(19) United States
(12) Patent Application Publication
(10) Pub. No.: US 2015/0179052 A1
(43) Pub. Date: Jun. 25, 2015

(54) Fire Detection System for Building Exterior

(71) Applicant: Mckenzie Covington, Rifle, CO (US)

(72) Inventor: Mckenzie Covington, Rifle, CO (US)

(21) Appl. No.: 14/580,555

(22) Filed: Dec. 23, 2014

Related U.S. Application Data
(60) Provisional application No. 61/920,345, filed on Dec. 23, 2013.

(51) Int. Cl. G08B 25/14; G08B 25/08; G08B 29/14; G08B 17/10

(52) U.S. Cl. CPC G08B 25/14; G08B 17/10; G08B 25/08; G08B 29/145

(57) ABSTRACT

Provided is a fire detection and alarm system for detecting fires along the exterior of a budding. The system has one or more detection units and one or more monitoring computers in communication with each other. Each monitoring computer may communicate with multiple speakers mounted throughout interior of building, a display monitor, optional video cameras, and may be configured to communicate with local authorities via a telecommunications network. Computer units are in communication with each other at all times, transmitting and receiving signals that indicate no fire has been detected. In the event that the signal line, which is mounted underneath existing siding is damaged, the proper signal will fail to be received by at least one monitoring computer. The effected monitoring computer will then send a signal to the camera units (if installed) as well as the display monitor, speakers, and transmit an alert to local authorities.

### CROSS REFERENCE TO RELATED APPLICATION

This application claims the benefit of U.S. Provisional Application No. 61/920,345 filed on Dec. 23, 2013, entitled “Exterior Fire Detection System.” The above-identified patent application is herein incorporated by reference in its entirety to provide continuity of disclosure.

### BACKGROUND OF THE INVENTION

1. Field of the Invention

The present invention relates to fire detection systems. More specifically, the present invention relates to a system that is configured to alert the occupants of a building if a fire starts along the building exterior or in unoccupied areas of the building.

Fires pose a significant threat to buildings and their inhabitants. For this reason, buildings in the United States both residential and commercial are required to have working fire detection systems. These systems are installed on or integrated into the ceilings of buildings. Some fire detection systems employ environmental sensors such as smoke detectors, thermal change monitors, and carbon dioxide detectors. Others rely on the destruction of an electrical connection such as a circuit, in order to trip the systems. Once a fire is detected, audible, tactile, or visual alarms, may be presented to the inhabitants of a building. Local authorities may be alerted as needed.

Fires starting on or travelling to the exterior of a building present a problem for common fire detection systems because the systems are generally not capable of detecting the presence of the exterior fire. Lack of exterior fire detection may be due to sensors placed only within the building interior, or circuitry disposed within exterior walls only. In some environments, wild fires, flash fires, and other outdoor fires pose a serious threat to buildings, making the development of an exterior fire detection system essential.

2. Description of the Prior Art

Devices have been disclosed in the prior art that relate to fire detection and prevention systems. These include devices that have been patented and published in patent application publications. These devices generally relate to indoor fire detection systems. The following is a list of devices deemed most relevant to the present disclosure, which are herein described for the purposes of highlighting and differentiating the unique aspects of the present invention, and further highlighting the drawbacks existing in the prior art.

Lindgren, U.S. Pat. No. 2,847,662 teaches a fire alarm system using a plurality of relay wires extending between lamps. Relay wires are laid in parallel and have circuit gates that are open during normal environmental conditions. In the event of a fire, the excessive heat causes the circuit gates to close, thereby enabling the flow of electricity to the lamps. In this manner, lamps are used to provide a visual indication that a fire has been detected by the system. Unlike the present invention, the Lindgen system does not include video cameras, constant transmission of no-fire signals between system nodes, or detection of a fire based on the failure of signal receipt.

Jorgensen, U.S. Pat. No. 2,667,630 teaches a fire alarm system that employs thermonegative resistors. The resistors are disposed in pairs, with one member of each pair being coated in heat resistant material. In the event of fire, one resistor may become damaged thereby creating a change in current flow between the two resistors. This change can be detected and used as affirmation of the presence of a fire. The Jorgensen invention does not include video cameras, constant signal transmission between nodes, or the detection of a fire based on loss of signal. A similar system is taught in Walthard et al, U.S. Pat. No. 3,678,510, which teaches a fire detection system using circuit monitoring techniques.

Vassil et al, U.S. Pat. No. 2,871,466 teaches an automatic fire detection system. The system has multiple fire detection loops having resistance wires having fixed temperature elements. As changes in temperature are detected within the fire detection loops, an alarm or light may be activated. Unlike the present invention, Vassil does not include constant signal transmission, and detection of a fire upon termination of signal transmission, nor does it teach the activation of video cameras. Another similar system is taught by Ekman, U.S. Pat. No. 2,028,653. Ekman teaches another fire alarm system. Ekman disclose a system having a plurality of fire detection loops with thermostatic wire protectors. Ekman suffers from the same disadvantages as Vassil, which are overcome by the present invention.

These prior art devices have several known drawbacks. They do not include initiation of remote viewing via video cameras, nor do they include fire detection via termination of signal. It substantially diverges in design elements from the prior art and consequently it is clear that there is a need in the art for an improvement to existing fire alarm systems. In this regard the instant invention substantially fulfills these needs.

### SUMMARY OF THE INVENTION

In view of the foregoing disadvantages inherent in the known types of fire alarm systems now present in the prior art, the present invention provides a new building exterior fire detection system wherein the same can be utilized for providing convenience for the user when desiring notification of fires along a building exterior.

It is therefore an object of the present invention to provide a new and improved fire alarm system that has all of the advantages of the prior art and none of the disadvantages.

It is another object of the present invention to provide a fire alarm system adapted for use on building exteriors. The system is scalable and may be adapted for use with buildings of large or small dimension.

Another object of the present invention is to provide a fire alarm system that captures video footage of the environment surrounding a detected fire. The footage may then be presented to a user via a monitoring computer, thereby aiding the user in formulating a plan for orderly evacuation of the building. In embodiments of the system where no video cameras are installed, an overhead view or structural map of the building may be displayed on the display, with the effected portions of the building illuminated or color coded.

Yet another object of the present invention is to provide a fire alarm system that provides live visual feedback of enflamed areas of a building. This functionality aids users in determining if a fire is spreading and in what directions it travels.

Still another object of the present invention is to provide a fire alarm system that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a general system diagram of an embodiment of the fire alarm system.

FIG. 2 shows an exemplary diagram of the components of an embodiment of a transmission node of a fire alarm system.

FIG. 3 shows a schematic diagram of an embodiment of a fire alarm system.

### DETAILED DESCRIPTION OF THE INVENTION

Reference is made herein to the attached drawings. Like reference numerals are used throughout the drawings to depict like or similar elements of the fire alarm system. For the purposes of presenting a brief and clear description of the present invention, the preferred embodiment will be discussed as used for detecting fires along a building exterior. The figures are intended for representative purposes only and should not be considered to be limiting in any respect.

In the following disclosure, the term “exemplary” does not refer to or imply a preferred embodiment, optimal configuration of parts, or any other term of degree. Rather, exemplary refers to an example of a possible configuration, meant to indicate to one of ordinary skill in the art, how the fire alarm and detection system might be implemented.

The term “signal” as used herein, is not limited to any one particular form of signal. It may encompass radio wave transmissions, digital data delivery techniques, electric impulses, or any other signal means known in the art of information communications. For the purpose of simplicity, the term “signal” will be generally used herein to describe digital data transmissions, however this usage is for exemplary purposes and is not intended to limit the scope of the type of signals, or signal transmission and delivery means that may be employed in embodiments of the fire alarm and detection system.

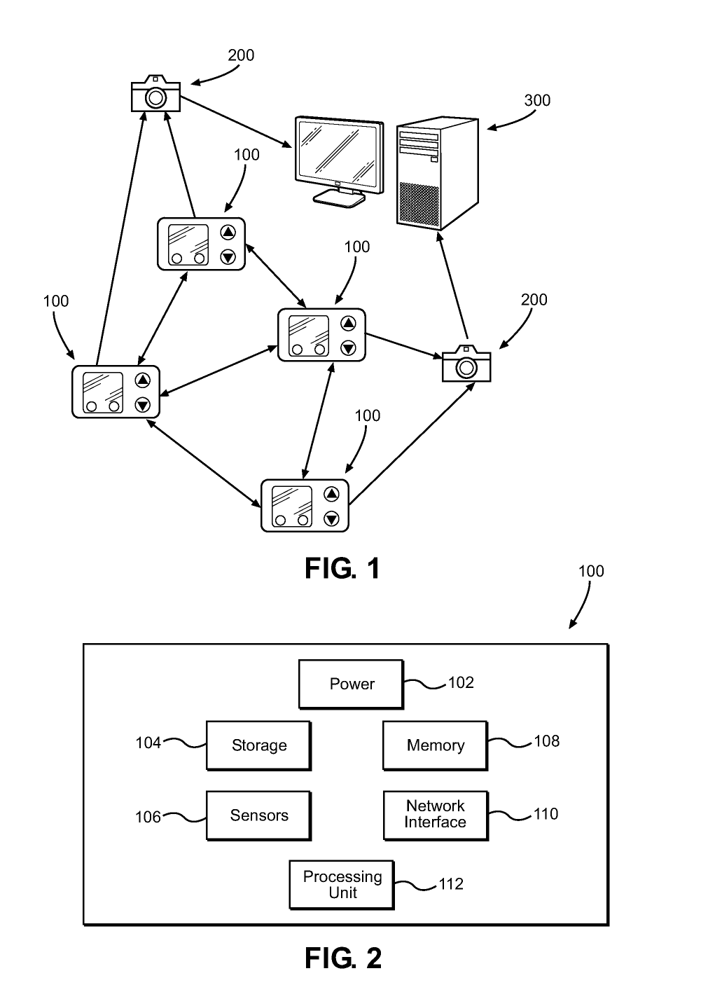

Referring now to FIG. 1, there is shown an embodiment of a fire detection system. The system has two or more detection units 100 in communication with at least one monitoring station 300 and multiple video cameras 200, speakers, and one or more display units. Connections may be network cables, electrical wires, or the like. In an exemplary embodiment described herein, the detection unit computers 100 are connected via network cables that facilitate constant signal transmission and receipt between the detection units 100. Cables may be installed within the exterior walls of a building, such as underneath siding or stucco finish.

In various embodiments, the two or more detection units may be positioned at various locations along the interior of the building. Detection units should be installed within locations resistant to fire damage. Data signals may be transmitted between detection units 100 at pre-determined regular intervals. Signal intervals should be short so as to provide rapid fire detection. However, power conservation may be taken into consideration when determining signal transmission intervals. Upon receipt of a signal transmission, each detection unit 100 may acknowledge receipt and return a signal transmission to the sending detection unit 100. In alternative embodiments, signal transmission is not dependent upon receipt from another detection unit 100, and signals may be transmitted synchronously or asynchronously, as desired.

If a detection unit fails to receive a signal within the pre-determined time interval, it may wait a second cycle of the predetermined time interval. If a signal is received in the second time interval, normal operation may continue, with the skipped signal optionally being logged. If the signal is not received in the second time interval, a fire detection signal may be sent to the monitoring computer 300, which will then transmit activation signals to display units, audio speakers, and the closest video camera units 200. Further, an alert communication may be transmitted to local authorities.

In some embodiments video camera units 200 may be positioned advantageously along the building exterior. In an embodiment, video cameras 200 are deployed such that the range of their respective fields of view overlap, or cover most of the environment surrounding the building. After receiving an activation signal from one or more of the monitoring computers 300, the cameras begin to capture video and or audio of the surrounding environment. Captured data is transmitted via a network connection to one or more monitoring computers 300. As such, each of video cameras 200 may be equipped with network interfaces and/or wirelesses transceivers. In an embodiment, video cameras may not be installed with the system, and a display unit may provide a bird's eye view of budding with each wall on monitor having the capabilities to light up indicating affected wall.

Data received by monitoring computer 300 may be displayed on a display unit such that a user can easily view and/or listen to the captured data. In some embodiments, failure of one detection unit 100 to transmit a signal may result in the activation of all video cameras. In some embodiments, failure of a detection unit 100 to transmit a signal may result in activation of only those video cameras proximal to the detection unit. By way of example the one or more detection units 100 that do not receive a signal from the damaged unit, may send signals to the one or more monitoring computers 300, which then transmit activation signals to all or a portion of the video cameras 200 near the effected respective detection unit(s) 100. Footage captured by any or all of the cameras may be displayed on monitors of the one or more monitoring computers 300. In this manner, users may quickly ascertain the status of portions of the building exterior without having to exit the building to check on the location of a detected fire.

In some embodiments, detection units 100 may not communicate between each other, but may instead communicated only with monitoring computer 300. In some embodiments, detections units 100 may transmit signals to one or more monitoring computers at pre-determined intervals in the same manner as described with respect to intra-detection unit communications embodiments. In these embodiments, it may be the one or more monitoring computers 300 that fail to receive a signal and determine the presence of a fire, thereby eliminating the need for a detection unit 100 to transmit a fire alert signal to the one or more monitoring computers 300.

FIG. 2 illustrates a simple system diagram of components of an exemplary detection unit 100. Each unit has a power source 102 which may be a battery, an electrical connection to building power supply, or a combination thereof. The unit may have a memory 108, a storage media 104, a processing unit or other signal processing means 112, a network interface or transceiver 110, and one or more sensors 106. Sensors may include thermal indicators, which may also be used to trigger detection of a fire.

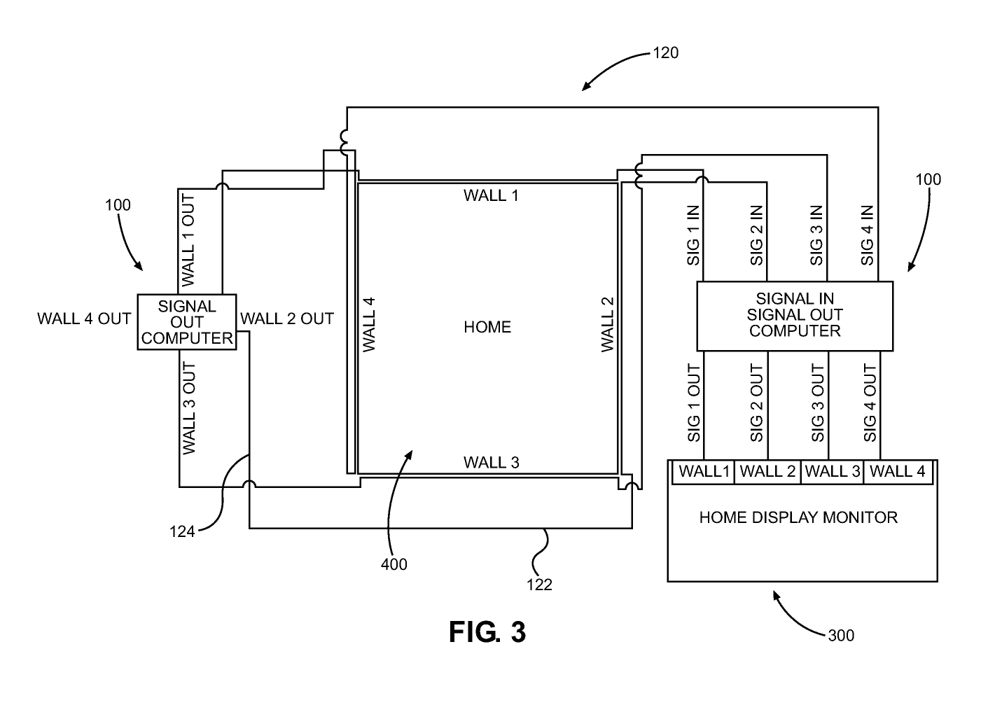

FIG. 3 shows an exemplary schematic of a fire detection and alarm system. The walls of a house 400 have signal communication lines 120, 122, etc. installed along and within the building exterior. A first detection unit 100 and a second detection unit 100 are in communication via the signal communication lines 120, 122, etc. Monitoring computer 300 is also in communication with the detection units, audio speakers, display units, and optional video cameras such that the detection of a fire by any detection unit, based on failure to receive signals from the opposing unit, will result in a signal being sent to the monitoring computer, which then triggers the display of video feedback, and audio output. Information about the area in which the fire was detected may also be displayed on the monitor. For example, information such as the specific detection unit that failed, location of the unit, distance to the next unit, and the like, may be displayed to a user, to provide information that may be used in formation of a building exit strategy.

In various embodiments, there is provided a fire alarm and detection system that is adapted for use with the exterior of a building. Alarm systems may be connected together to cover multiple buildings or an entire complex. The system is scalable to fit a variety of structure sizes and accuracy needs. Fewer detection units 100, audio speakers, display units, and video cameras 200 may be used to conserve monetary resources, while larger numbers of detection units 100, video cameras, 200 and monitoring computers 300 may be needed for large complexes. Further, the modular design of the system enables easy configuration, and adaptability to a variety of structural designs.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A fire detection system, comprising:
a plurality of fire detection units configured for installation within a building, wherein said detection units are configured to transmit and receive signals therebetween; and
one or more monitoring computers in data communication with said detection units such that said detection units send activation signals to said one or more monitoring computers to indicate that a fire event has been; and
one or more display units in communication with said one or more monitoring computers and configured to display data received from said one or more monitoring computers and said detection units on a monitor; and
wherein a fire is detected wherein one or more of said detection units fails to receive a signal from another of said detection unit after a predetermined time interval.

2) The system of claim 1, wherein said detection units are communicatively connected via signal communication lines.

3) The system of claim 2, wherein said signal communication lines are installed within a building exterior.

4) The system of claim 2, wherein said signal communication lines are installed along an exterior surface of a building exterior.

5) The system of claim 2, wherein said signal communication lines are network cables configured to carry data signals.

6) The system of claim 1, wherein each of said detection units is communicatively connected to only said detection units that are proximal to it.

7) The system of claim 1, wherein each of said detection units is communicatively coupled to all other of said detection units.

8) The system of claim 1, further comprising:
a plurality of video cameras in communication with said one or more monitoring computers such that said one or more monitoring computers transmit activation signals to said video cameras to begin recording.

9) The system of claim 8, wherein each of said one or more monitoring computers only sends activation signals to video cameras proximal to detection units that have positively detected a fire event.

10) The system of claim 8, wherein said one or more monitoring computers is configured to present feedback of data received from said video cameras simultaneously.

11) The system of claim 1, wherein said one or more monitoring computers are located remotely from said building.

12) The system of claim 1, further comprising a plurality of speakers in communication with said monitoring computer such that said one or more monitoring computers transmit activation signals to said speakers to initiate audio output.

13) The system of claim 1, wherein failure to receive a signal from one or said detection units after a pre-determined interval is logged and transmitted to said one or more monitoring computers.

14) The system of claim 1, wherein failure to receive a signal from one or more of said detection units may be followed by a second pre-determined interval of time to establish whether a second failure occurs.

15) The system of claim 14, wherein the second failure triggers transmission of a first activation signal from said detection unit to said one or more monitoring computers, which transmits a second activation signal to said display units.

16) A fire detection system, comprising:
a plurality of fire detection units configured for installation within a building; and
one or more monitoring computers in data communication with said detection units such that said detection units send activation signals to said one or more monitoring computers to indicate that a fire event has been; and
one or more display units in communication with said one or more monitoring computers and configured to display data received from said one or more monitoring computers and said detection units on a monitor; and
a plurality of speakers in communication with said monitoring computer such that said one or more monitoring computers transmit activation signals to said speakers to initiate audio output.

17) The system of claim 16, further comprising:
a plurality of video cameras in communication with said one or more monitoring computers such that said one or more monitoring computers transmit activation signals to said video cameras to begin recording.

18) The system of claim 17, wherein each of said one or more monitoring computers only sends activation signals to video cameras proximal to detection units that have positively detected a fire event.

19) The system of claim 17, wherein said one or more monitoring computers is adapted to present feedback of data received from said video cameras simultaneously.

20) The system of claim 16, wherein a fire is detected wherein one or more of said monitoring computers fails to receive a signal from any of said detection unit after a predetermined time interval.

21) The system of claim 20, wherein failure to receive a signal from one or more of said detection units may be followed by a second pre-determined interval of time to establish whether a second failure occurs.

22) The system of claim 21, wherein the second failure triggers transmission of an activation signal from one or said monitoring computers to said speakers and said display units.
